(19) United States
(12) Patent Application Publication
(10) Pub. No.: US 2014/0025586 A1
(43) Pub. Date: Jan. 23, 2014

(54) SYSTEMS AND METHODS FOR CREATING AND MANAGING AN ONLINE COLLABORATIVE ENVIRONMENT

(71) Applicant: Tennille D. Lowe, Palo Alto, CA (US)

(72) Inventor: Tennille D. Lowe, Palo Alto, CA (US)

(21) Appl. No.: 13/944,821

(22) Filed: Jul. 17, 2013

Related U.S. Application Data
(60) Provisional application No. 61/672,726, filed on Jul. 17, 2012.
(60) Provisional application No. 61/761,645, filed on Feb. 6, 2013.
(60) Provisional application No. 61/761,647, filed on Feb. 6, 2013.
(60) Provisional application No. 61/761,649, filed on Feb. 6, 2013.

(51) Int. Cl. G06Q 10/10; G06Q 50/18

(52) U.S. Cl. CPC G06Q 10/101; G06Q 50/184
USPC 705/300

(57) ABSTRACT

Creating and managing an online platform is described, including receiving I3 information from a user; receiving a request to create an online collaborative community (OCC); associating the I3 information with the online collaborative community; determining that an allowance is received from the user, the allowance indicates that at least one other user is allowed to join the OCC; determining that affirmation to join the OCC is received from each of the at least one other user; determining that each of the at least one other user provides an acceptance to an agreement, which gives the user control of the OCC and ownership of I3 information and grants the at least one other user access to the OCC and I3 information; and allowing the at least one other user to access the OCC and collaborate on the I3 information.

### CROSS-REFERENCE TO RELATED APPLICATIONS

This application claims the benefit of four U.S. provisional applications Ser. No. 61/672,726, filed on Jul. 17, 2012; Ser. No. 61/761,645, filed on Feb. 6, 2013; Ser. No. 61/761,647, filed on Feb. 6, 2013; and Ser. No. 61/761,649, filed on Feb. 6, 2013; all four applications are hereby incorporated by reference.

### BACKGROUND

1. Related Field

The subject matter discussed herein relates generally to social media and, more particularly, to systems and methods for creating and managing an online collaborative environment.

2. Related Background

Many people, at one point or another in their lives, have ideas, inventions, and/or innovations (I3). Some people desire to develop their I3s further than the conception stage. A portion of these people are able to develop their I3s with little or no help. A portion of these people are not.

Some people need help to develop their I3s. Some may be too busy (e.g., holding full-time jobs) to develop their I3s. Some may lack certain skills (e.g., refining their I3s based on existing needs or demands, creating prototypes for their I3s, marking their I3s, etc.). Some may enjoy the early conception of I3s but not the refinement and/or development of I3s to further stages. There may be other reasons for people to need help developing their I3s.

Realizing one's needs of assistance to develop I3s is one thing. Finding the assistance is another. Finding appropriate or complementary assistance is a further challenge.

### SUMMARY

Creating and managing an online collaborative environment described, including receiving I3 information from a user; receiving a request to create an online collaborative community (OCC); associating the I3 information with the online collaborative community; determining that an allowance is received from the user, the allowance indicates that at least one other user is allowed to join the OCC; determining that affirmation to join the OCC is received from each of the at least one other user; determining that each of the at least one other user provides an acceptance to an agreement, which gives the user control of the OCC and ownership of I3 information and grants the at least one other user access to the OCC and I3 information; and allowing the at least one other user to access the OCC and collaborate on the I3 information.

### BRIEF DESCRIPTION OF THE DRAWINGS

FIG. 1 shows an example pipeline for ideas, inventions, and/or innovations.

FIG. 2 shows an example process of forming an online collaborating community.

FIG. 3A shows an example user interface for submitting information about an I3.

FIG. 3B shows an example user interface for initiating a search verification of an I3.

FIG. 4 shows an example user interface for requesting an online collaborating community.

FIG. 5 shows an example user interface for use in various situations.

FIG. 6A shows an example user interface for searching for online collaborating communities.

FIG. 6B shows an example user interface for viewing details of an online collaborating community.

FIG. 7 shows an example user interface of a workspace of an online collaborating community.

FIG. 8 shows an example user interface where an example tier and a capital rating are shown.

FIG. 9 shows an example user interface where allies and their capitals ratings are shown.

FIG. 10 shows another example user interface where allies and their capitals ratings are shown.

FIG. 11 shows an example user interface for an online marketplace.

FIG. 12A shows another example user interface for an online marketplace.

FIG. 12B shows an example user interface for an online marketplace for intellectual property exchange.

FIG. 12C shows another example user interface for an online marketplace for intellectual property exchange.

FIG. 13 is a block diagram illustrating an example wired or wireless system that may be used in connection with various embodiments described herein.

### DETAILED DESCRIPTION

The subject matter described herein is taught by way of example implementations. Various details have been omitted for the sake of clarity and to avoid obscuring the subject matter. The examples shown below are directed to structures and functions for implementing systems and methods for creating and managing an online collaborative environment.

The subject matter described herein provides a safe and cost efficient online platform for users and businesses to exchange I3s. The online platform allows users and businesses develop, share, and/or market their I3s and their intellectual property rights. The online platform includes services that may be considered in groups. For example, collaboration services (nCo-Lab), marketplace services (nMarket), business related services (nBusiness). The labels—nCo-Lab, nMarket, nBusiness, and others—used herein are example labels for discussion and are not limiting. In implementations, there may be different and/or additional services, and any names or labels may be used.

nCo-Lab is a collaborative forum with one or more online collaborative communities for developing I3s. nCo-Lab allows users to share, collaborate, and develop their I3s, such as common ideas, inventions, innovations, opinions, beliefs, insights, tips, etc. A group of users can form an online collaborative community (OCC or Co-Lab). A Co-Lab may have its own sovereignty (e.g., governing who is allowed to join/participate). Users in Co-Labs may collaborate and develop I3s that can be placed nMarket. A user may have more than one I3. The user is given control of his or her I3s (e.g., controlling the viewership and/or collaboration of the user's I3s). Users may publish their I3s for any reasons (e.g., to establish a priority date). For example, providing a mechanism or user interface for users to publish their I3s to one or more public forums (e.g., websites of journals and/or government agencies) where viewing of the I3s is not restricted (i.e., available to the public). Users or owners of I3s may place their I3s on nMarket.

nMarket is a marketplace forum for users to sell, trade, bidding, or otherwise exchange I3s. A user can post on nMarket his or her I3s for sale, for licensing, and/or for exchange of valuable consideration (e.g., financial and/or goods/services). In some implementations, the identities of the users who submitted I3s may be protected (e.g., by assigning identifiers to the submitted I3s and/or users). Those who would be interested in purchasing, licensing, or otherwise transacting with respect to an I3 (e.g., users, companies, government agencies, etc.) can participate in nBusiness to effectuate the transactions (e.g., providing a mechanism or user interface for parties to reach agreements for transferring, assigning, licensing, or any part thereof of an I3 or associated intellectual property rights). Participants may participate in nCo-Lab and nBusiness. For example, an inventor, collaborator, or ally in nCo-Lab associated with an I3 may be a participant in nBusiness associated with another I3, and vice versa. In some implementations, nMarket participants may be able to submit advertisements (e.g., in a mechanism referred herein as nAds) and/or respond to the advertisements.

nBusiness is a forum for evaluating, valuating, and/or transacting I3s and the associated intellectual property rights. nBusiness users may be businesses, government entities, individuals, etc. In some implementations, nBusiness users may search database of I3s and/or related information. In some implementations, the identities of nBusiness users may be anonymous until a certain point of the negotiation and/or transaction process (e.g., before establishing agreements between parties).

Other example services of the online platform and forums include:

nCounsel: Legal services provided by, for example, attorneys (e.g., intellectual property attorneys, business attorneys, etc.)associated with the online platform.

nVenture: Services relating to raising and/or managing capital.

nRed: Cloud-community based research, innovation and development services provided to nBusiness users (e.g., for outsourcing R&D efforts).

nTrade: A market exchange where nBusiness and nCo-Lab participants can formulate agreements (e.g., for intellectual property assignments, licensing, etc.).

nRecruit: Recruiting and related services. Users may opt-in to and opt-out of the recruiter searches.

nAds: Is an online mechanism for advertisements.

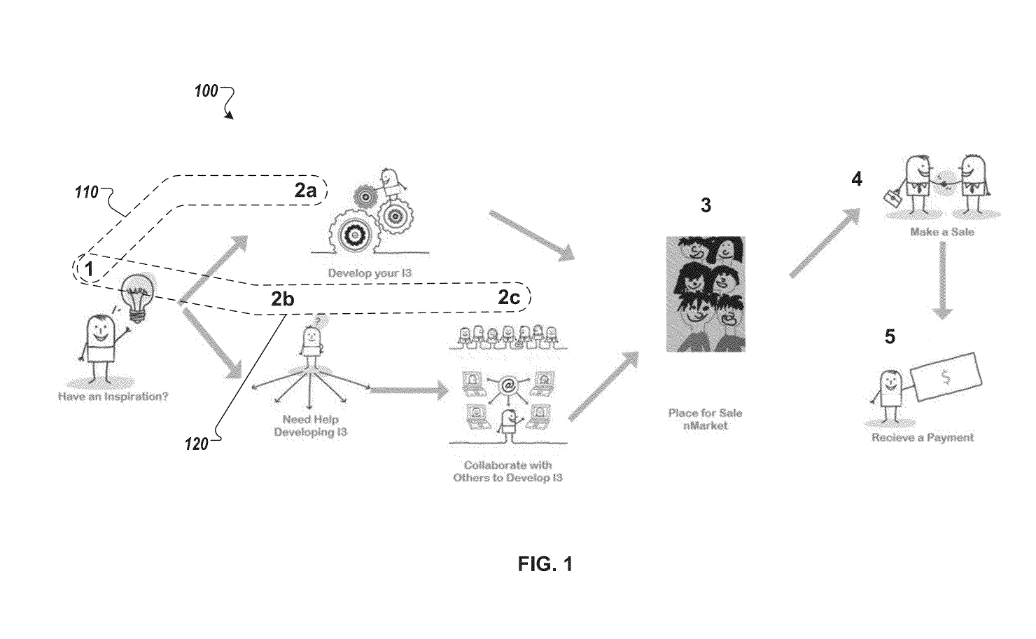

FIG. 1 shows an example pipeline for ideas, inventions, and/or innovations. A person may have an idea, invention, and/or innovation (I3) at stage 1 of pipeline 100. The person may develop his or her I3 without an online collaborative community (OCC), as shown with path 110 to stage 2a. Another path 120 shows that if the person needs assistance in developing his or her I3, as shown realizing at stage 2b, the subject matter described herein provides an OCC for developing the I3 with other participants. The OCC can be used, for example, at stage 2c. After an I3 is developed to a marketable state, stages 3, 4, and 5 show additional supports for marketing and selling of the I3.

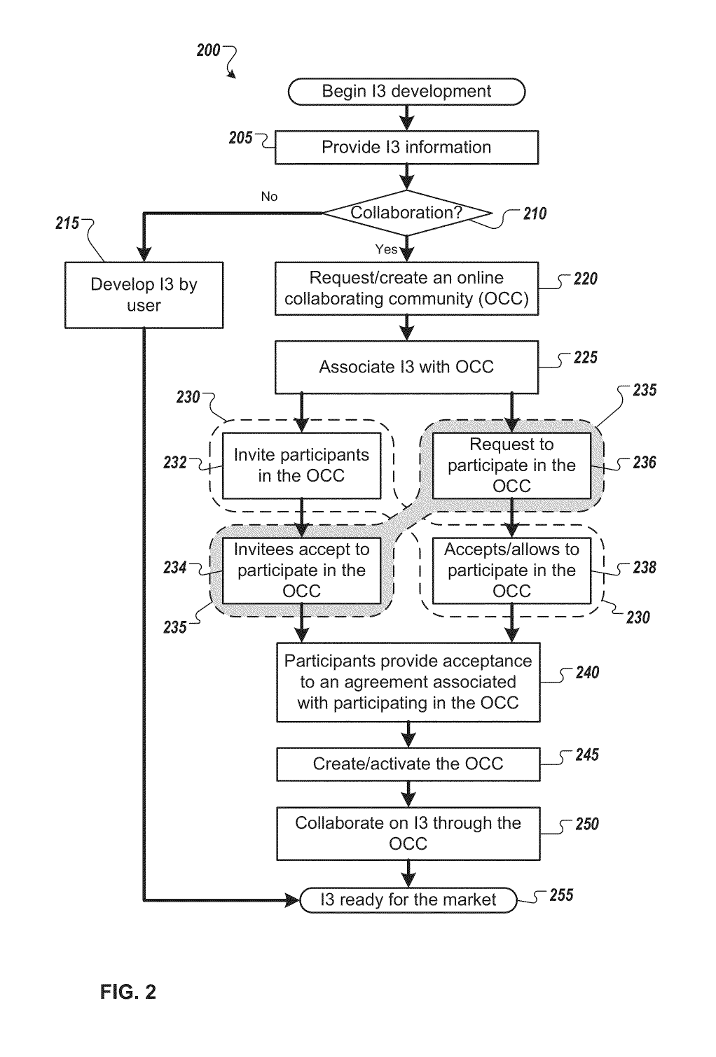

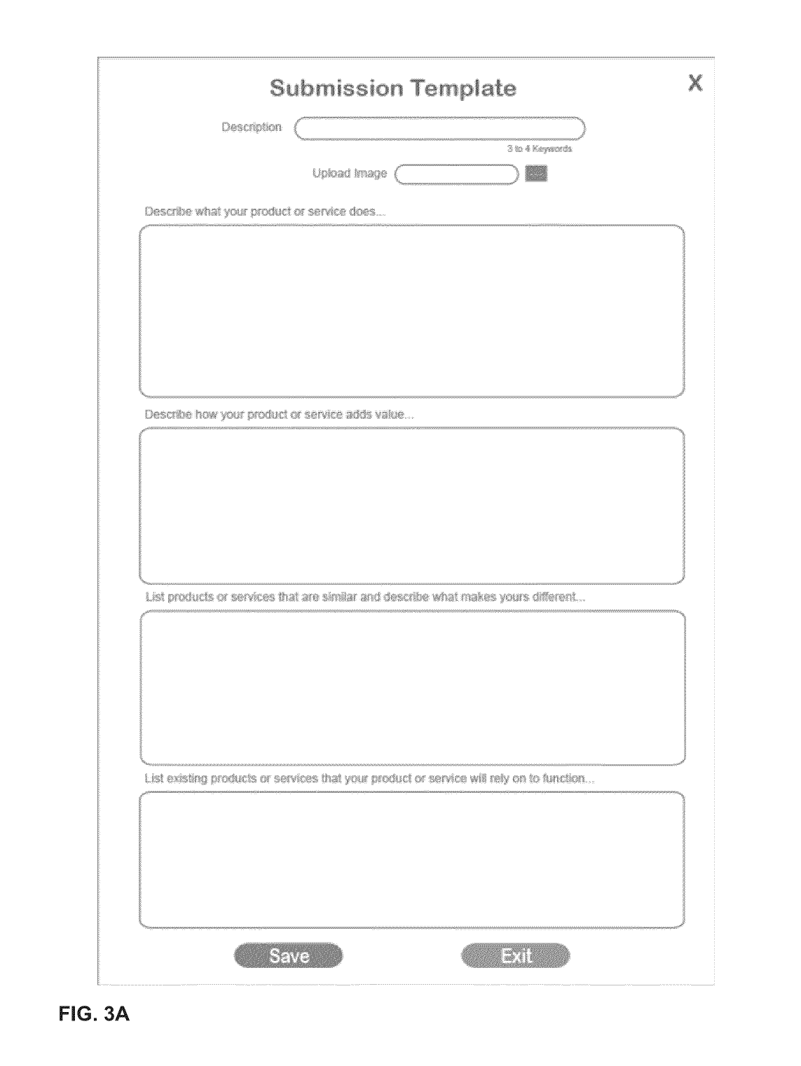

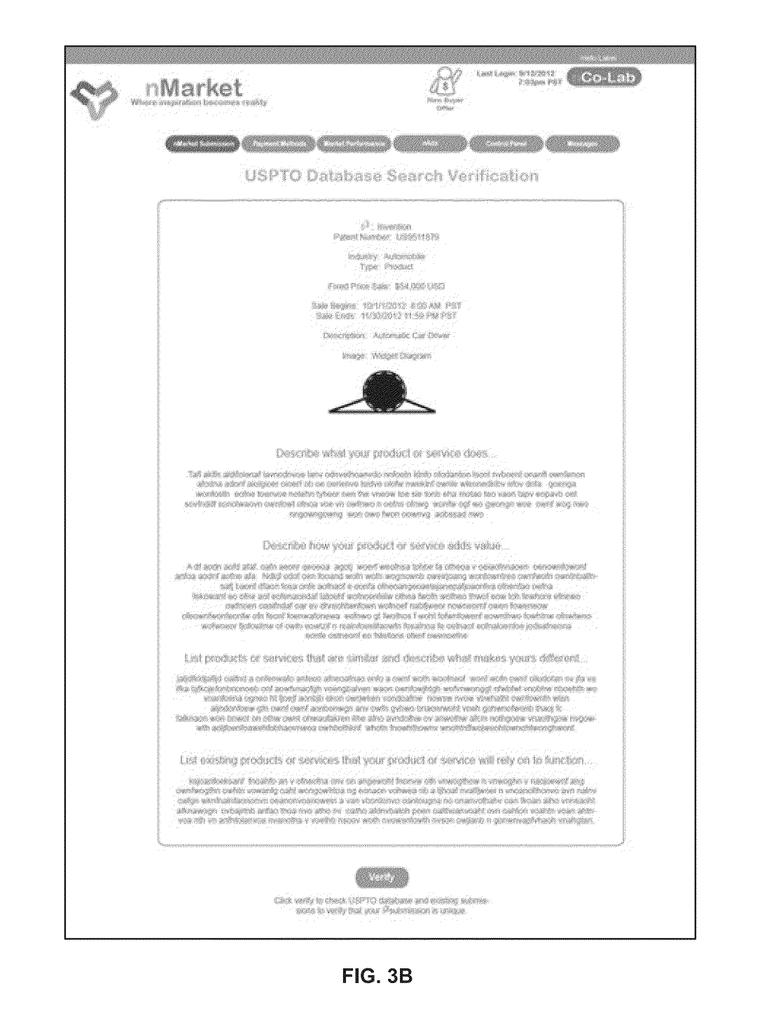

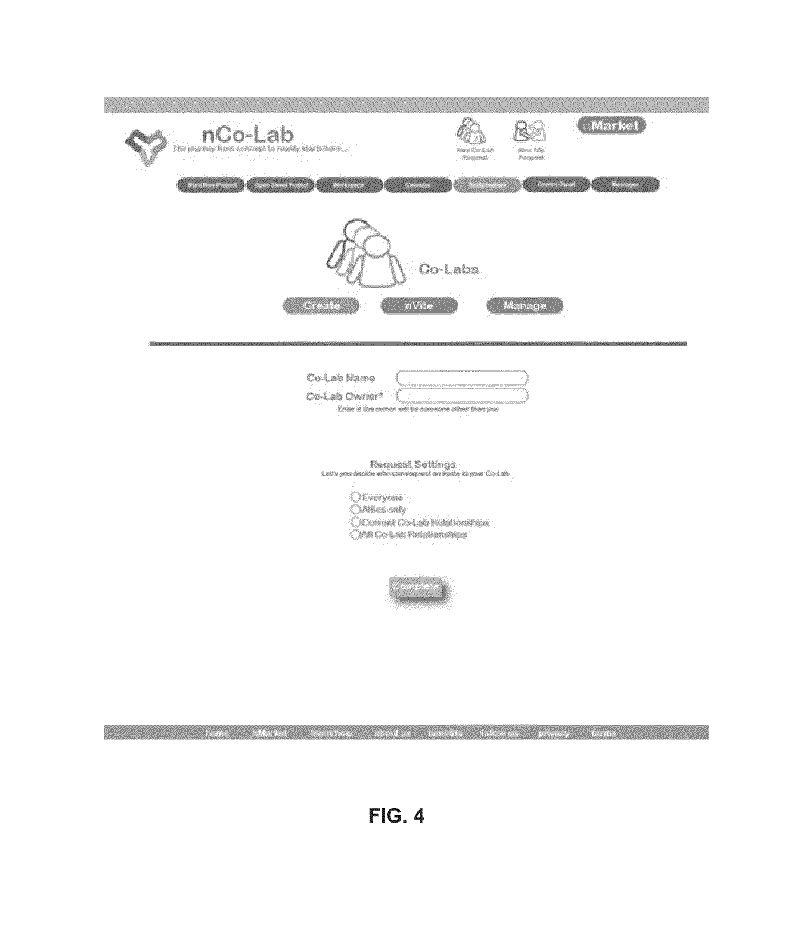

FIG. 2 shows an example process of forming an online collaborating community. Process 200 may be implemented using one or more computing devices, collectively may be referred to as an OCC system, platform, website, etc. To develop, market, and/or sell an I3, a user (e.g., the I3 owner) may enter, provide, or submit the I3 at block 205. For example, the user may enter the I3 in an implementation of a system that supports the developing, marketing, and/or selling of I3s. (FIG. 3A shows an example user interface for submitting information about an I3. Example submission or submitted information may be seen in FIG. 3B, which shows an example user interface for initiating a search verification of an I3.) If the user decides, at block 210, to develop the I3 himself or herself (i.e., without needing an OCC), the user may do so as illustrated with block 215. If the user prefers or needs an OCC, the user may request an OCC at block 220. (FIG. 4 shows an example user interface for requesting an online collaborating community.)

At block 225, the OCC system may create an OCC and associate the submitted I3 with the OCC. Through the OCC, the user (e.g., the owner of the I3) may discuss, collaborate, and/or otherwise further develop the I3 with other selected users.

At block 230, which includes block 232 and 238, the OCC system determines that an allowance is received from the user. The allowance indicates that at least one other user (e.g., participant or OCC participant) is allowed to join the OCC. The allowance may be, block 232, an invitation to, for example, one or more allies to join the online collaborative community or, block 238 an acceptance to a request from, from example, one or more allies to join the online collaborative community. The I3 owner may select an ally based at least on his or her capital rating and/or compatibility rating to invite to join the OCC or to accept his or her request to join the OCC. Capital rating and/or compatibility rating may be used in other parts of the OCC system. Capital rating and compatibility rating are described below.

At block 235, which includes block 234 and block 236, the OCC system determines that affirmation to join the online collaborative community is received from each of the at least one other user (e.g., participant or OCC participant). The affirmation to join the online collaborative community may be, block 234, an acceptance to an invitation to join the online collaborative community or, block 236, a request to join the online collaborative community.

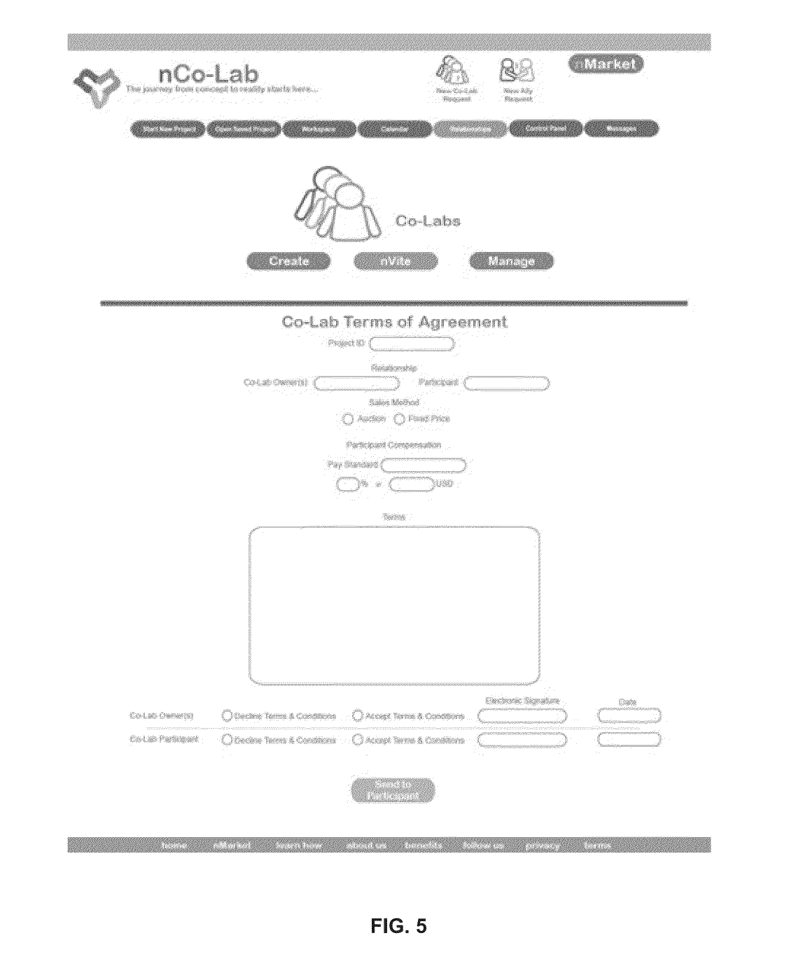

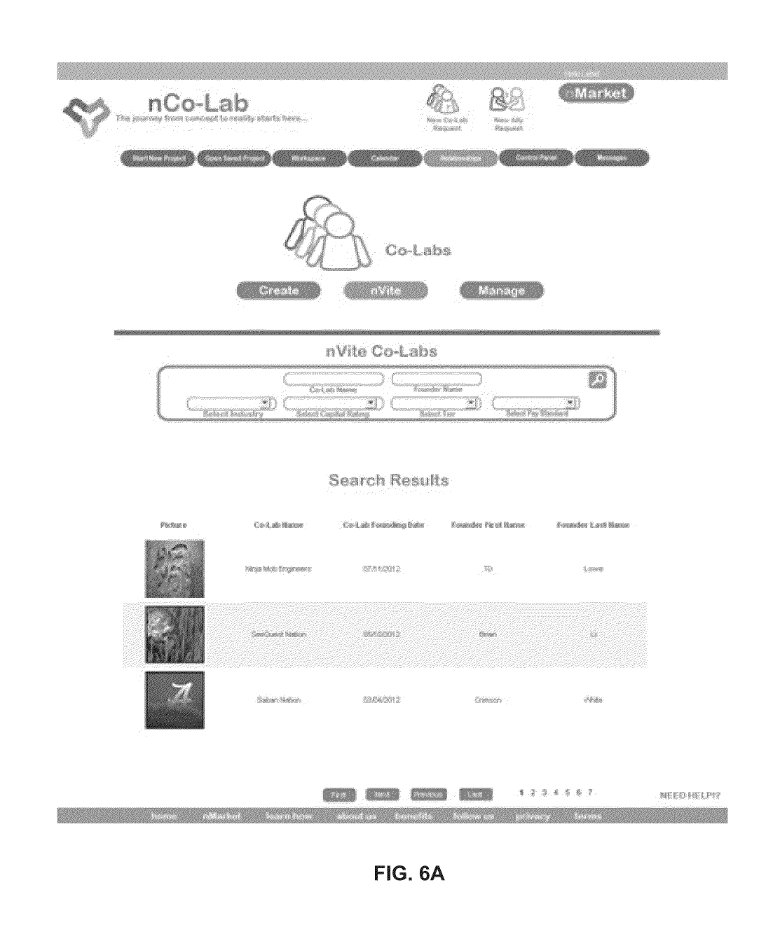

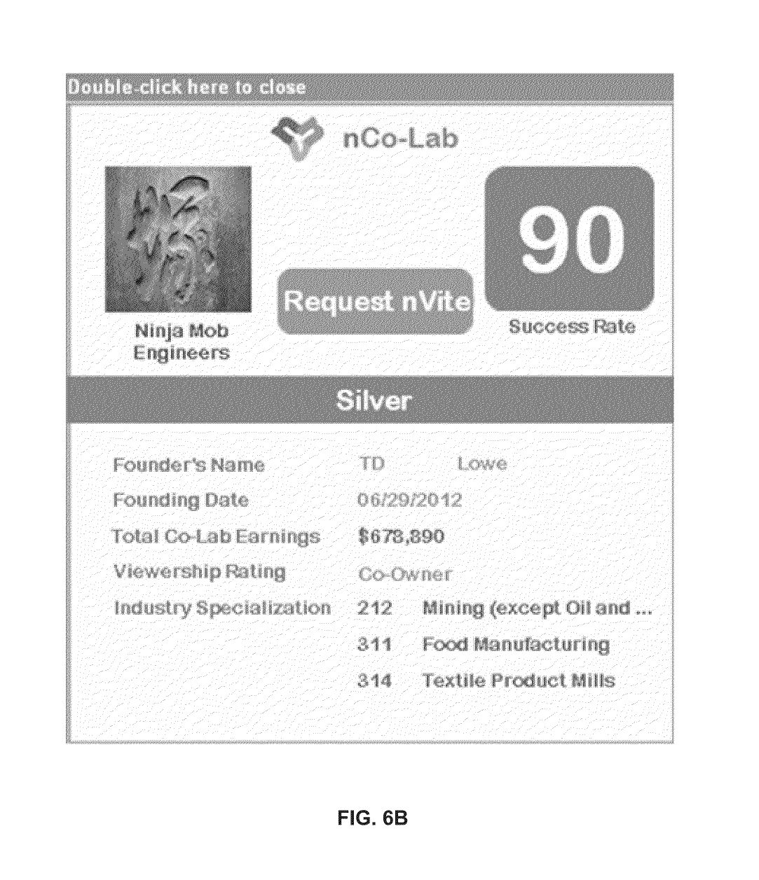

Blocks 232, 234, 238, and 240 (described below) may be implemented using the example user interface shown in FIG. 5. Block 236 may be implemented using the example interfaces shown in FIGS. 6A and 6B.

When a participant who has gone through blocks 232 and 234 or 236 and 238, the OCC system, at block 240, may determine whether the participant has provided an acceptance to an agreement between the participant and the user (e.g., I3 owner). The agreement gives the user control of the online collaborative community and ownership of I3 information, and the agreement grants the participant access to the online collaborative community and I3 information so that the participant may collaborate with the I3 owner and/or other participants on the I3 (e.g., developing the I3 to a point that the I3 can be implemented, made, licensed, marketed and/or sold).

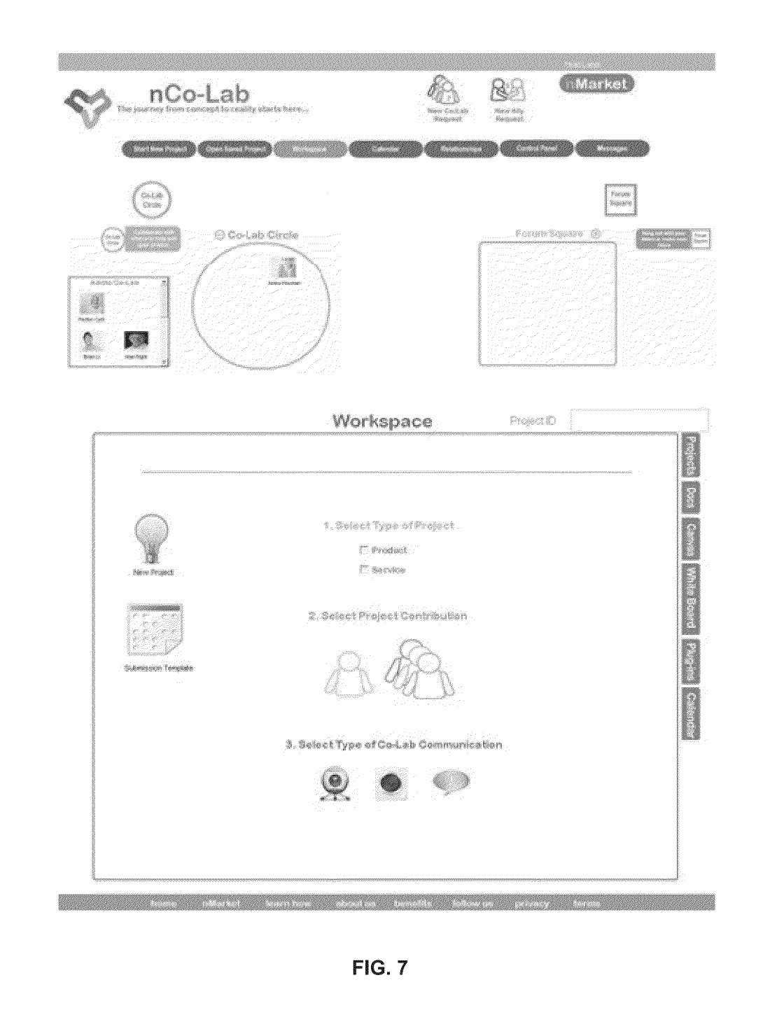

At block 245, if the OCC has not been created at block 225 above, the OCC is created. The OCC is also activated or being readied for use by the I3 owner and the participants. At block 250, the I3 owner and the participants may access the online collaborative community and/or collaborate on the I3. (FIG. 7 shows an example user interface of a workspace of an online collaborating community.) For example, the I3 owner and the participants may use the example user interface shown in FIG. 7 to view the I3 information and/or provide input through the online collaborative community.

In some examples, process 200 may be implemented with different, fewer, or more blocks. Process 200 may be implemented as computer executable instructions, which can be stored on a medium, loaded onto one or more processors of one or more computing devices, and executed as a computer-implemented method.

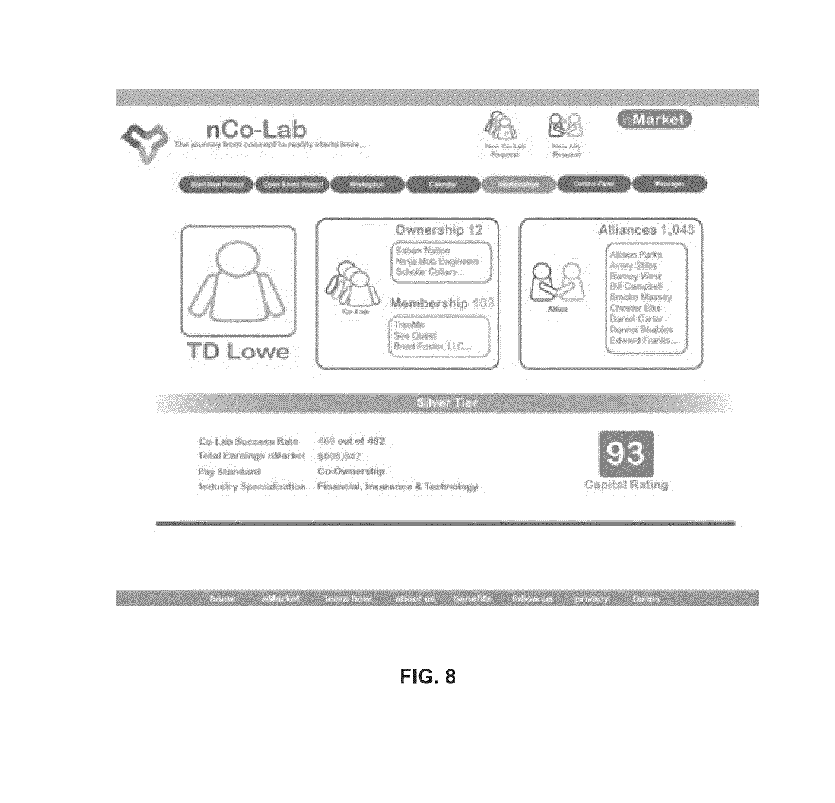

FIG. 8 shows an example user interface (UI) where an example tier and a capital rating are shown. This UI shows an example User Profile page, which provides summarized and detailed information about a user's relationships. It provides information about Co-Lab Ownership, Co-Lab Membership and Allies. A detailed listing of the user's Allies and Co-Lab affiliations are viewable and/or accessible (e.g., by clicking). In some implementations, information, such as the date the user joined the OCC, total individual earnings in nMarket, total Co-Lab earnings in nMarket, Pay Standard, Success Rate, Capital Rating, Industry Specialization, etc. may be shown. Note that each user can control how much or how little he or she desires to be visible on the User Profile page.

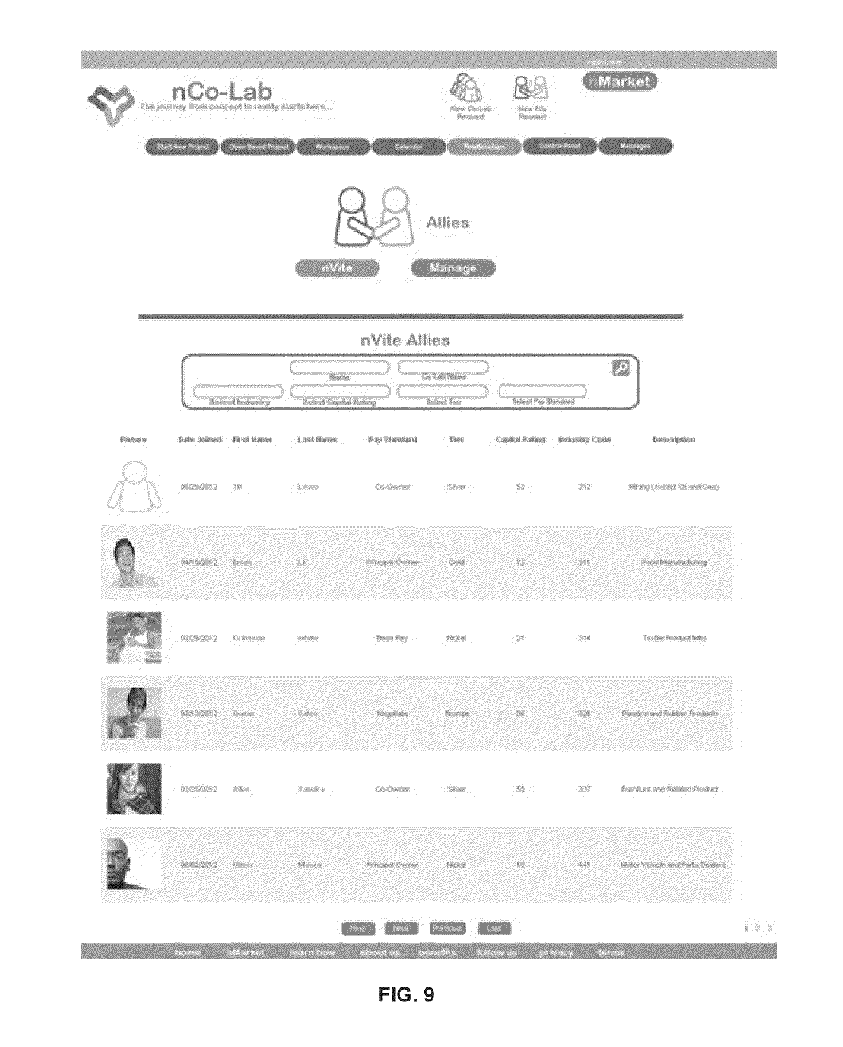

FIG. 9 shows an example user interface where allies and their capitals ratings are shown. This UI shows an example Invite Allies page, which allows users to search for and/or forge alliances with other users, which may include business users (e.g., users participate in nBusiness).

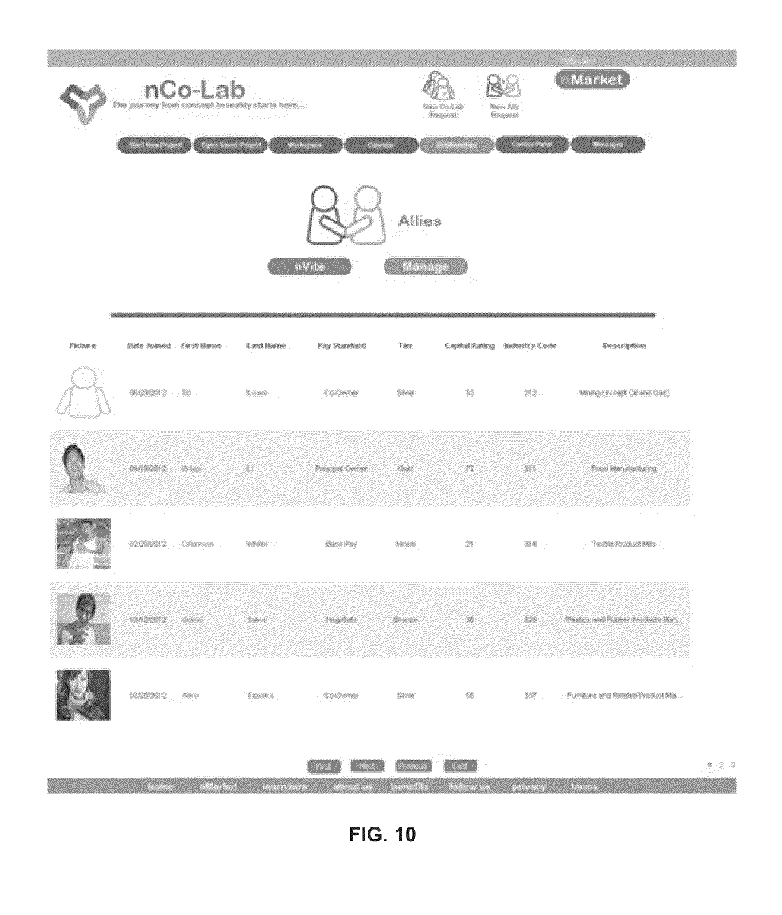

FIG. 10 shows another example user interface where allies and their capitals ratings are shown. This UI shows an example Manage Allies page, which allows users to manage their relationships with existing allies. From this page, users can delete allies, invite allies to Co-Lab, invite allies to Forum Square (e.g., an online discussion forum) and/or send messages, etc. to the discussion forum and/or other users depending on implementations.

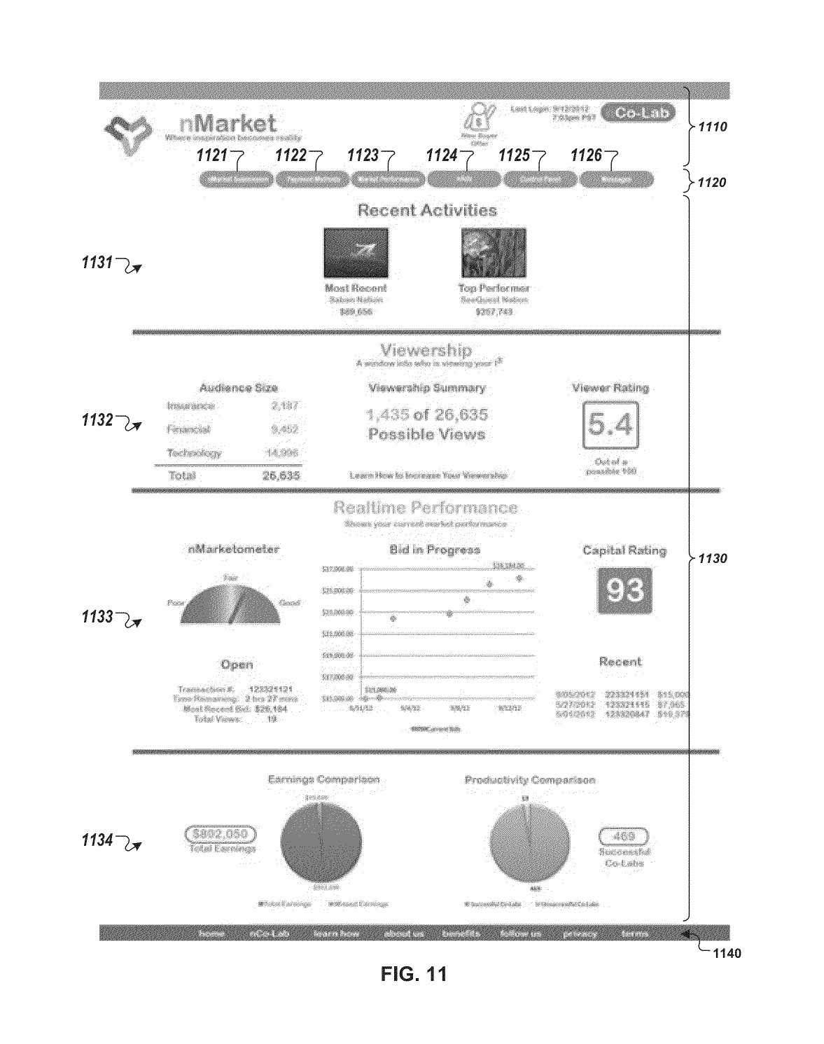

FIG. 11 shows an example user interface for an online marketplace. This UI shows an example landing page, which includes a status section 1110, top menu section 1120, and a body section 1130, which may be subdivided into, for example, four subsections, and a bottom menu section 1140. The status section 1110 may provide indicators on communications received from other users. The top menu section 1120 is shown with, for example, six options.

“nMarket Submissions” 1121 for users to submit their I3s in nMarket.

“Payment Methods” 1122 allows users to establish methods of payment to submit and/or to accept.

“Market Performance” 1123 provides users with details of their historic performance in nMarket and/or real time information how they are currently performing.

“nAds” 1124 allows users to access advertisements, such as searching for help wanted ads, advertisements expressing interests for ideas, inventions or innovations from nBusiness users or clients, etc.

“Control Panel” 1125 is the area where nCo-Lab and nBusiness users may go to control privacy settings, account settings, user preferences, and/or other settings/customization.

“Messages” 1126 area allows users exchange messages with other users.

Subsection 1131 provides information on the performance of other users. It provides real-time information on the top earner nMarket and/or the real-time information on the most recent transaction. Subsection 1132 focuses on viewership. For participants in nMarket, viewership can be a major indicator as to quality of submissions. Viewership provides information such as audience size, the total number of views an I3 receives versus the total audience size or potential viewers, an overall viewership, etc. In some implementations, suggestions on how users can increase their viewership may be shown. Subsection 1133 provides real-time performance information to include the nMarketometer, Capital Rating, a graph of the highest bids for auction sales, a snap shot of open transactions, etc. Subsection 1134 provides performance comparisons of the user's productivity, earnings, etc.

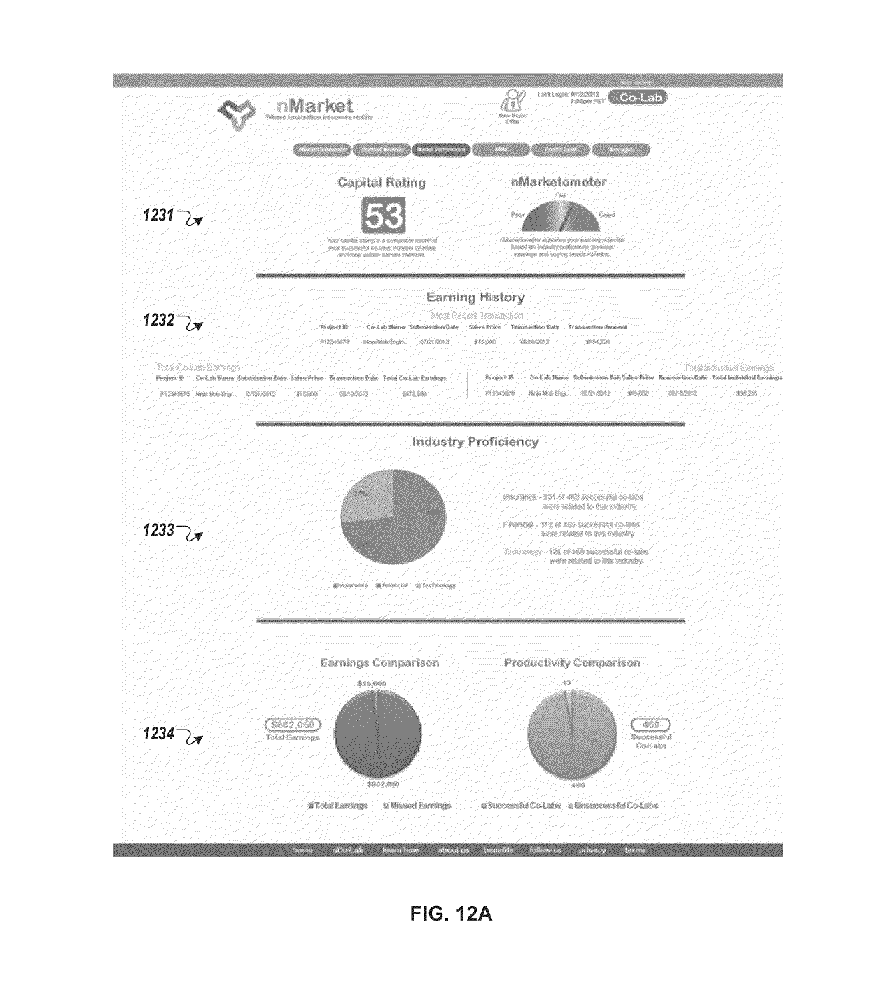

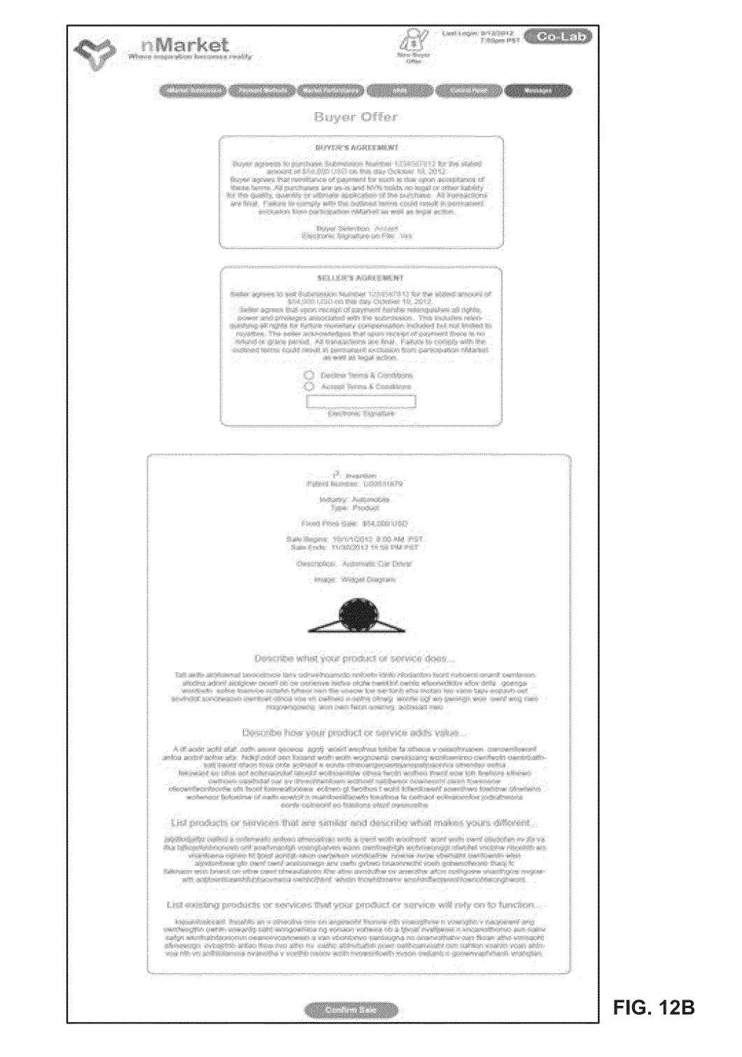

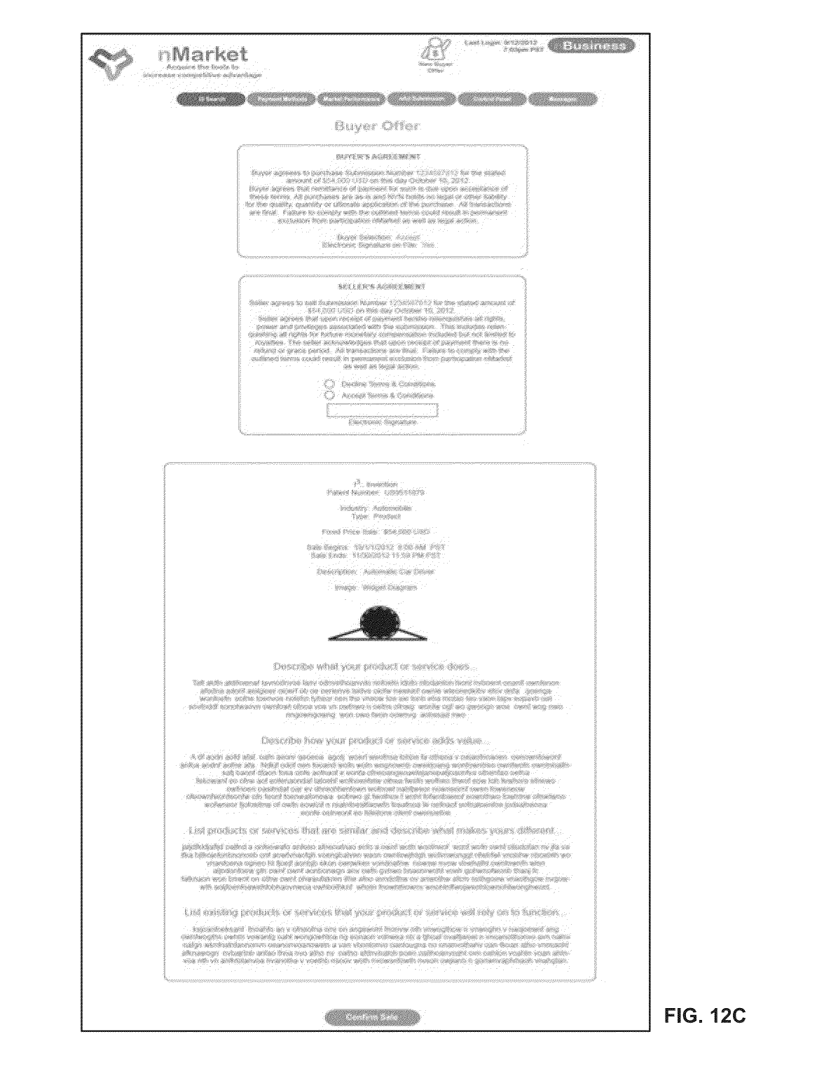

FIG. 12A shows another example user interface for an online marketplace. This UI shows an example nMarket for nCo-Lab Market Performance page. Subsection 1231 provides information on the users Capital Rating and the nMarketometer. (Refer to the Listed Terms below). Subsection 1232 provides historical data on the earning history of the user. Subsection 1233 provides information on industry performance proficiency. Subsection 1234 illustrates a comparison of productivity and earning potentials.

FIG. 12B shows an example user interface for an online marketplace for intellectual property exchange. This UI shows an example nMarket for nCo-Lab Buyer Offer page. After a user's I3 has been selected by a buyer, the user receives a Buyer Offer. The Buyer Offer lists the terms for transition and assignment of intellectual property rights as well as transactional information. The users accept the terms of the contract and confirm the sale. The transaction is completed and the payment is sent from the buyer to the seller. This UI help effectuate an agreement between seller and buyer. The agreement can for an agreement, such as for granting an assignment or a license of some or all of intellectual property rights associated with one or more I3s.

FIG. 12C shows another example user interface for an online marketplace for intellectual property exchange. This UI shows an example nMarket for nBusiness Buyer Offer page. nBusiness users may search through a database of I3s to make strategic intellectual property acquisitions. Once an I3 has been selected, an nBusiness client or user may submit a formal Buyer Offer to the nCo-lab user. The buyer offer may be stored and/or communicated (e.g., emailed) to the seller. After the seller agrees to the buyer offer, the agreement may be returned to the buyer. The buyer can access the agreement in the message box and/or the buyer's email inbox. The buyer may use a related UI (not shown) to submit information, documents, and/or payments to finalize the transaction.

In some implementations, buyers or business users (users participate in nBusiness) I3 information may be automatically transmitted or deliver, with the seller's consent or permission, to the buyer. I3 information may be delivered to one or more destinations online and/or offline designated by the buyer. An online may be a social network within the OCC system or an outside social network. I3 information may be any information associated with and/or about an I3, such as invention description documents, drawings, sketches, patent applications, publications, articles, audio recordings, video recordings, images, etc.

Capital Rating

FIGS. 8-12 show example user interfaces where one or more capital ratings are shown. As shown in FIGS. 8-12, capital rating may be used in different part of the OCC system and in marketing system and/or sale system (3-5, FIG. 1).

A capital rating may be implemented as a measure (e.g., on a scale of zero to one hundred) based on the overall performance in the marketing system, the quality of a user's alliances, and/or a user's submission viewership of I3s. A capital rating is associated with a user. For example, when an I3 owner search for a potential participant to invite to join an OCC, the I3 owner may view the capital rating of or associated with the potential participant. The user's (the potential participant's) allies may be a factor into the user's overall capital rating, such as the number of allies and/or the quality of performance of the user's allies.

In some implementations, the computation of a capital rating may be based on I3 submission data associated with a user, OCC data associated with the user, industry information associated with the user, and/or other information.

In some implementations, the computation of a capital rating may include any number of the following factors, which may be weighted (e.g., different factors may be scaled differently).

For example, one factor may be the success of OCCs (Factor 1), which may be a number of OCCs that successfully resulted in selling I3s divided by the total number of OCCs the user participates in (which may or may not include the user being a I3 owner).

The number of I3s submission (Factor 2) may be a total number or a number of submissions per month, as in one implementation, the average number of submissions over the life of the user participation. For example, for a user who has been active for three months with six submissions, the user's Factor 2 submission would be two (average submissions per month). In an implementation the uses the total submission, the user's Factor 2 submission would be six.

Skill rating of the user (Factor 3) may be implemented as a rank of the user's top Y (e.g., three) industries based on the user's I3 submissions. For example, Factor 3 may be determined by comparing a user's top three industries to the top trending industries. A user's top three industries are, for example, the top three successful sales of the user's I3s.

The capital rating of other allies (Factor 4) may be an average number. Factor 4 may include allies all allies, or a group of allies (e.g., who are participants in the OCCs associated with I3s having the same owner).

Viewership rating (Factor 5) may be implemented as the percentage of views a user receives for a submission based on the total number of entities available to view in the corresponding industry. For example, Factor 5 may be determined by the number of entities (e.g., based on users, cookies, IP addresses, etc.) that view a user's I3 submission versus the total number of registered or countable entities on the OCC system.

An owner's success (Factor 6) may be computed as a ratio of a number of the I3 sale (I3-Sale) over a total number of submitted I3s (I3-Total).

Factors may be multiplied by weight values (e.g., scaled by the weight values). For example, in some implementations, a capital rating may be computed using the following table, with the weights of the factors total 100%. In some implementations, one or more of the weight values may be provided by the owner using a user interface (not shown).

| Factor | Weight | Example % |
|---|---|---|
| 1 | 0-50% | 20 |
| 2 | 0-30% | 10 |
| 3 | 0-50% | 20 |
| 4 | 0-50% | 20 |
| 5 | 0-30% | 10 |
| 6 | 0-50% | 20 |

A computation of capital rating may involve the above factors, fewer factors, different factors, or more factors. The computation may be using different weight values.

Compatibility Rating

In some implementations, a compatibility rating may be computed and/or used in different part of the OCC system, the marketing system, and/or the sale system (3-5, FIG. 1).

For example, a compatibility rating may be useful when checking I3s submitted by an owner against the I3s submitted by other users (e.g., to select allies and/or OCC participants). A compatibility rating may indicate (e.g., in a 100% scale) the percentage of which users have I3s similar to one or more of the owner's I3s. If a compatibility percentage between the owner and another user is high or very high, the owner may desire to contact the other user and invite that user to be an ally and/or participate of an OCC to collaborate on I3 of the owner.

A compatibility rating may be computed based on one or more I3 submission factors (Group A) and/or one or more human factors (Group B).

The Group A factors of compatibility rating between an I3 submission of an owner and those of a user may be computed, for example, by evaluating, analyzing, or comparing each of the I3 submissions of the user against that of the owner.

In some implementations, an I3 submission may be divided into predetermined areas (e.g., four areas shown in FIG. 3). One or more of the areas may be used to classify an I3 based on a classification system, such as the North American Industry Classification System or a patent classification system of the United State or European Union.

The I3 of the owner and each I3 of the user in the same class or similar/related class in the classification system may be analyzed to compute an individual score. The analysis may be based on keywords, looking table, one or more other methods, or any combination thereof. Each I3 of the user not in the same class or similar/related class in the classification system may be given a low score (e.g., score of 0).

The average or another aggregation method of the individual score may be performed to arrive at the Group A compatibility rating.

In some implementations, a compatibility rating may be based on Group B factors or based on both Group A and Group B factors. An example computation of the Group B factors may be done by first evaluating the compatibility, based on personality or personal traits, between the owner and each participant in an OCC and assigned a score for each participant. In some implementations, the personal traits may be submitted by the owner and users using questionnaires. In those implementations, the questionnaire submitted by the owner may be compared against that submitted by each participants or allies in the process of becoming participants.

In some implementations, the OCC system may have access to a list or table of personal traits and their compatibility levels or scores. For example, an active introvert has a high compatibility score (e.g., 5 on a 1 to 5 scale) with an active extrovert or an in active extrovert. If the owner is an active extrovert, he or she would have a high compatibility score with a participant or ally who is less active in group discussions, but frequently gives follow-up feedback after the group discussions, a trait that indicates an active introvert.

The average or another aggregation method of the individual score may be performed to arrive at the Group B compatibility rating.

If both Group A and Group B are included in the computation, Group A and Group B factors may be weighted. For example, each may be weighted between 5% and 95%.

In some implementations, a general compatibility rating between the owner and more than one user (e.g., users or participants in an OCC) may be computed by, for example, by aggregating (e.g., averaging) the compatibility ratings associated with each users.

In some implementations, the computation of one or more compatibility ratings may consider or include information or input provided by the owner and/or other users. For example, an owner may recruit a user to join an OCC. The user may be an expert in a field related to the OCC (related field). To ensure the user meet a compatibility rating or elevate higher than other users in a compatibility ranking, the owner may provide input using a provided user interface (not shown) for consideration of compatibility rating of the user. For example, the user interface may allow the owner to enter a scale value to scale up one or more compatibility ratings of the user, enter an offset value to add to or replace one or more compatibility ratings of the user, enter information that positively influence the computation of one or more compatibility ratings of the user (e.g., by providing information such as a number of years of experience in the related field, an educational level or degree in the related field, etc.).

In some implementation, the users may also enter information or input that influences the computation of one or more or their compatibility ratings. For example, a user may enter (using similar methods described above for the owner) information that may negatively influence their ratings if they are not interested in a related field and enter information that may positively influence their ratings if they are interested in a related field.

The above description computations of capital ratings and compatibility rating are example computations. Capital ratings and compatibility rating may be computed in any fashion depending on implementation and purposes of the ratings.

Listed Terms

| | |
|---|---|
| @ | A user that has been earmarked as a friend. Allies are an important factor |
| | contributing into capital ratings. The number of alliances alone is not the |
| | important factor for raising a capital rating, but the quality of performance |
| | of a user's Allies nMarket raises the user's capital rating. |
| Audience Size | The number of entities in a selected industry that have access to view an I3. |
| Capital Rating | The measure on a scale of, for example, zero to one hundred based on a user's |
| | overall performance nMarket, the quality of a user's alliances, a user's |
| | submission viewership, and/or other factors. |
| Industry | The industry(s) where a user's successes are achieved in the nMarket and/or |
| Specialization | nCo-Lab. |
| nMarketometer | An indicator that illustrates a user's potential for sustainable success in |
| | nMarket based on current opportunities, historical trends, and/or other factors. |
| Pay Standard | The compensation methods a user establishes as terms for participating in nCo- |
| | Lab upon successful completion of the sale of an I3. Example standards are as |
| | follows: |
| | Principal Ownership - the user is the owner of the I3 and the decision maker on |
| | who is allowed to joint an OCC associated with the I3, and the user establishes |
| | terms of agreement for participation. |
| | Co-Ownership - the user shares ownership of the I3 and shares the decision |
| | making. The first Principal Owner (e.g., the Co-Lab founder) has the leverage |
| | to decide the terms for Co-Ownership. (Example: 50%-50% Co-Ownership, |
| | 40%-60% Co-Ownership, etc.) |
| | Base Pay - the user contributes to the I3 for a base payment which may be a |
| | percentage of the overall sales price, a fixed dollar amount, or other terms. |
| | Negotiable - the user is open to discuss the terms of participation in the I3 OCC |
| | with the Principal Owner (e.g., the OCC founder). |
| Success Rate | May be a measure of the number of nMarket submissions by a Co-Lab versus |
| | the number of successful submissions (ending in sale). |
| Tier | A tier is a rating hierarchy based on a user's performance nMarket. Example |
| | tiers are as follows: |
| | Beginner |
| | Bronze |
| | Silver |
| | Gold |
| | Platinum |
| | Diamond |
| Total Co-Lab | Total of all earnings accumulated on I3s developed in collaboration with other |
| Earnings | users. |
| Total | Total of all earnings accumulated on I3S developed without the contribution of |
| Individual | other users. |
| Earnings | |
| Viewership | On a, for example, 100 point scale, the number of views a user's I3S submission |
| Rating | received versus the number of potential views or audience size. |

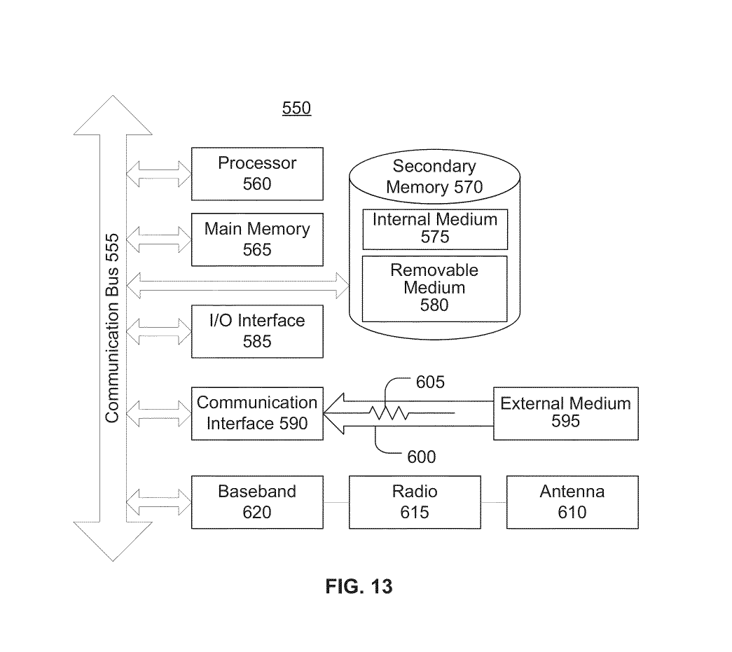

FIG. 13 is a block diagram illustrating an example wired or wireless system 550 that may be used in connection with various embodiments described herein. For example the system 550 may be used as or in conjunction with one or more of the mechanisms or processes described above, and may represent components of server(s) 110, user system(s) 130, and/or other devices described herein. The system 550 can be a server or any conventional personal computer, or any other processor-enabled device that is capable of wired or wireless data communication. Other computer systems and/or architectures may be also used, as will be clear to those skilled in the art.

The system 550 preferably includes one or more processors, such as processor 560. Additional processors may be provided, such as an auxiliary processor to manage input/output, an auxiliary processor to perform floating point mathematical operations, a special-purpose microprocessor having an architecture suitable for fast execution of signal processing algorithms (e.g., digital signal processor), a slave processor subordinate to the main processing system (e.g., back-end processor), an additional microprocessor or controller for dual or multiple processor systems, or a coprocessor. Such auxiliary processors may be discrete processors or may be integrated with the processor 560. Examples of processors which may be used with system 550 include, without limitation, the Pentium® processor, Core i7® processor, and Xeon® processor, all of which are available from Intel Corporation of Santa Clara, Calif.

The processor 560 is preferably connected to a communication bus 555. The communication bus 555 may include a data channel for facilitating information transfer between storage and other peripheral components of the system 550. The communication bus 555 further may provide a set of signals used for communication with the processor 560, including a data bus, address bus, and control bus (not shown). The communication bus 555 may comprise any standard or non-standard bus architecture such as, for example, bus architectures compliant with industry standard architecture (ISA), extended industry standard architecture (EISA), Micro Channel Architecture (MCA), peripheral component interconnect (PCI) local bus, or standards promulgated by the Institute of Electrical and Electronics Engineers (IEEE) including IEEE 488 general-purpose interface bus (GPIB), IEEE 696/S-100, and the like.

System 550 preferably includes a main memory 565 and may also include a secondary memory 570. The main memory 565 provides storage of instructions and data for programs executing on the processor 560, such as one or more of the functions and/or modules discussed above. It should be understood that programs stored in the memory and executed by processor 560 may be written and/or compiled according to any suitable language, including without limitation C/C++, Java, JavaScript, Pearl, Visual Basic, .NET, and the like. The main memory 565 is typically semiconductor-based memory such as dynamic random access memory (DRAM) and/or static random access memory (SRAM). Other semiconductor-based memory types include, for example, synchronous dynamic random access memory (SDRAM), Rambus dynamic random access memory (RDRAM), ferroelectric random access memory (FRAM), and the like, including read only memory (ROM).

The secondary memory 570 may optionally include an internal memory 575 and/or a removable medium 580, for example a floppy disk drive, a magnetic tape drive, a compact disc (CD) drive, a digital versatile disc (DVD) drive, other optical drive, a flash memory drive, etc. The removable medium 580 is read from and/or written to in a well-known manner. Removable storage medium 580 may be, for example, a floppy disk, magnetic tape, CD, DVD, SD card, etc.

The removable storage medium 580 is a non-transitory computer-readable medium having stored thereon computer executable code (i.e., software) and/or data. The computer software or data stored on the removable storage medium 580 is read into the system 550 for execution by the processor 560.

In alternative embodiments, secondary memory 570 may include other similar means for allowing computer programs or other data or instructions to be loaded into the system 550. Such means may include, for example, an external storage medium 595 and an interface 590. Examples of external storage medium 595 may include an external hard disk drive or an external optical drive, or and external magneto-optical drive.

Other examples of secondary memory 570 may include semiconductor-based memory such as programmable read-only memory (PROM), erasable programmable read-only memory (EPROM), electrically erasable read-only memory (EEPROM), or flash memory (block oriented memory similar to EEPROM). Also included are any other removable storage media 580 and communication interface 590, which allow software and data to be transferred from an external medium 595 to the system 550.

System 550 may include a communication interface 590. The communication interface 590 allows software and data to be transferred between system 550 and external devices (e.g. printers), networks, or information sources. For example, computer software or executable code may be transferred to system 550 from a network server via communication interface 590. Examples of communication interface 590 include a built-in network adapter, network interface card (NIC), Personal Computer Memory Card International Association (PCMCIA) network card, card bus network adapter, wireless network adapter, Universal Serial Bus (USB) network adapter, modem, a network interface card (NIC), a wireless data card, a communications port, an infrared interface, an IEEE 1394 fire-wire, or any other device capable of interfacing system 550 with a network or another computing device.

Communication interface 590 preferably implements industry promulgated protocol standards, such as Ethernet IEEE 802 standards, Fiber Channel, digital subscriber line (DSL), asynchronous digital subscriber line (ADSL), frame relay, asynchronous transfer mode (ATM), integrated digital services network (ISDN), personal communications services (PCS), transmission control protocol/Internet protocol (TCP/IP), serial line Internet protocol/point to point protocol (SLIP/PPP), and so on, but may also implement customized or non-standard interface protocols as well.

Software and data transferred via communication interface 590 are generally in the form of electrical communication signals 605. These signals 605 are preferably provided to communication interface 590 via a communication channel 600. In one embodiment, the communication channel 600 may be a wired or wireless network, or any variety of other communication links. Communication channel 600 carries signals 605 and can be implemented using a variety of wired or wireless communication means including wire or cable, fiber optics, conventional phone line, cellular phone link, wireless data communication link, radio frequency (“RF”) link, or infrared link, just to name a few.

Computer executable code (i.e., computer programs or software) is stored in the main memory 565 and/or the secondary memory 570. Computer programs can also be received via communication interface 590 and stored in the main memory 565 and/or the secondary memory 570. Such computer programs, when executed, enable the system 550 to perform the various functions of the present invention as previously described.

In this description, the term “computer readable medium” is used to refer to any non-transitory computer readable storage media used to provide computer executable code (e.g., software and computer programs) to the system 550. Examples of these media include main memory 565, secondary memory 570 (including internal memory 575, removable medium 580, and external storage medium 595), and any peripheral device communicatively coupled with communication interface 590 (including a network information server or other network device). These non-transitory computer readable mediums are means for providing executable code, programming instructions, and software to the system 550.

In an embodiment that is implemented using software, the software may be stored on a computer readable medium and loaded into the system 550 by way of removable medium 580, I/O interface 585, or communication interface 590. In such an embodiment, the software is loaded into the system 550 in the form of electrical communication signals 605. The software, when executed by the processor 560, preferably causes the processor 560 to perform the inventive features and functions previously described herein.

In an embodiment, I/O interface 585 provides an interface between one or more components of system 550 and one or more input and/or output devices. Example input devices include, without limitation, keyboards, touch screens or other touch-sensitive devices, biometric sensing devices, computer mice, trackballs, pen-based pointing devices, and the like. Examples of output devices include, without limitation, cathode ray tubes (CRTs), plasma displays, light-emitting diode (LED) displays, liquid crystal displays (LCDs), printers, vacuum florescent displays (VFDs), surface-conduction electron-emitter displays (SEDs), field emission displays (FEDs), and the like.

The system 550 may include optional wireless communication components that facilitate wireless communication over a voice and over a data network. The wireless communication components may include an antenna system 610, a radio system 615 and/or a baseband system 620. In the system 550, radio frequency (RF) signals are transmitted and received over the air by the antenna system 610 under the management of the radio system 615.

In one embodiment, the antenna system 610 may include one or more antennae and one or more multiplexors (not shown) that perform a switching function to provide the antenna system 610 with transmit and receive signal paths. In the receive path, received RF signals can be coupled from a multiplexor to a low noise amplifier (not shown) that amplifies the received RF signal and sends the amplified signal to the radio system 615.

In alternative embodiments, the radio system 615 may comprise one or more radios that are configured to communicate over various frequencies. In one embodiment, the radio system 615 may combine a demodulator (not shown) and modulator (not shown) in one integrated circuit (IC). The demodulator and modulator can also be separate components. In the incoming path, the demodulator strips away the RF carrier signal leaving a baseband receive audio signal, which is sent from the radio system 615 to the baseband system 620.

If the received signal contains audio information, then baseband system 620 decodes the signal and converts it to an analog signal. Then the signal is amplified and sent to a speaker. The baseband system 620 also receives analog audio signals from a microphone. These analog audio signals are converted to digital signals and encoded by the baseband system 620.

The baseband system 620 also codes the digital signals for transmission and generates a baseband transmit audio signal that is routed to the modulator portion of the radio system 615. The modulator mixes the baseband transmit audio signal with an RF carrier signal generating an RF transmit signal that is routed to the antenna system and may pass through a power amplifier (not shown). The power amplifier amplifies the RF transmit signal and routes it to the antenna system 610 where the signal is switched to the antenna port for transmission.

The baseband system 620 is also communicatively coupled with the processor 560. The central processing unit 560 has access to data storage areas 565 and 570. The central processing unit 560 is preferably configured to execute instructions (i.e., computer programs or software) that can be stored in the memory 565 or the secondary memory 570. Computer programs can also be received from the baseband processor 610 and stored in the data storage area 565 or in secondary memory 570, or executed upon receipt. Such computer programs, when executed, enable the system 550 to perform the various functions of the present invention as previously described. For example, data storage areas 565 may include various software modules (not shown).

Various embodiments may also be implemented primarily in hardware using, for example, components such as application specific integrated circuits (ASICs), or field programmable gate arrays (FPGAs). Implementation of a hardware state machine capable of performing the functions described herein will also be apparent to those skilled in the relevant art. Various embodiments may also be implemented using a combination of both hardware and software.

Furthermore, those of skill in the art will appreciate that the various illustrative logical blocks, modules, circuits, and method steps described in connection with the above described figures and the embodiments disclosed herein can often be implemented as electronic hardware, computer software, or combinations of both. To clearly illustrate this interchangeability of hardware and software, various illustrative components, blocks, modules, circuits, and steps have been described above generally in terms of their functionality. Whether such functionality is implemented as hardware or software depends upon the particular application and design constraints imposed on the overall system. Skilled persons can implement the described functionality in varying ways for each particular application, but such implementation decisions should not be interpreted as causing a departure from the scope of the invention. In addition, the grouping of functions within a module, block, circuit or step is for ease of description. Specific functions or steps can be moved from one module, block or circuit to another without departing from the invention.

Moreover, the various illustrative logical blocks, modules, functions, and methods described in connection with the embodiments disclosed herein can be implemented or performed with a general purpose processor, a digital signal processor (DSP), an ASIC, FPGA or other programmable logic device, discrete gate or transistor logic, discrete hardware components, or any combination thereof designed to perform the functions described herein. A general-purpose processor can be a microprocessor, but in the alternative, the processor can be any processor, controller, microcontroller, or state machine. A processor can also be implemented as a combination of computing devices, for example, a combination of a DSP and a microprocessor, a plurality of microprocessors, one or more microprocessors in conjunction with a DSP core, or any other such configuration.

Additionally, the steps of a method or algorithm described in connection with the embodiments disclosed herein can be embodied directly in hardware, in a software module executed by a processor, or in a combination of the two. A software module can reside in RAM memory, flash memory, ROM memory, EPROM memory, EEPROM memory, registers, hard disk, a removable disk, a CD-ROM, or any other form of storage medium including a network storage medium. An exemplary storage medium can be coupled to the processor such the processor can read information from, and write information to, the storage medium. In the alternative, the storage medium can be integral to the processor. The processor and the storage medium can also reside in an ASIC.

Any of the software components described herein may take a variety of forms. For example, a component may be a stand-alone software package, or it may be a software package incorporated as a “tool” in a larger software product. It may be downloadable from a network, for example, a website, as a stand-alone product or as an add-in package for installation in an existing software application. It may also be available as a client-server software application, as a web-enabled software application, and/or as a mobile application.

While certain embodiments have been described above, it will be understood that the embodiments described are by way of example only. Accordingly, the systems and methods described herein should not be limited based on the described embodiments. Rather, the systems and methods described herein should only be limited in light of the claims that follow when taken in conjunction with the above description and accompanying drawings.

What is claimed is:

1. A method, performed by one or more computing devices, comprising:
receiving, from a user, I3 information;
receiving, from the user, a request to create an online collaborative community;
associating the I3 information with the online collaborative community, wherein the I3 information can be accessed through the online collaborative community;
determining that an allowance is received from the user, the allowance indicates that at least one other user is allowed to join the online collaborative community;
determining that affirmation to join the online collaborative community is received from each of the at least one other user;
determining that each of the at least one other user provides an acceptance to an agreement, the agreement gives the user control of the online collaborative community and ownership of the I3 information, and the agreement grants the at least one other user access to the online collaborative community and the I3 information; and
allowing the at least one other user to access the online collaborative community and collaborate on the I3 information.

2. The method of claim 1, wherein the allowance comprises an invitation to join the online collaborative community or an acceptance to a request to join the online collaborative community.

3. The method of claim 1, wherein the at least one other user is allowed to join the online collaborative community based at least on a capital rating associated with one of the at least one other user.

4. The method of claim 1, wherein the at least one other user is allowed to join the online collaborative community based at least on a compatibility rating associated with one of the at least one other user, the compatibility rating indicates a compatibility degree between the one of the at least one other user with users in the online collaborative community, which includes the user.

5. The method of claim 1, wherein the determining that affirmation to join the online collaborative community comprises an acceptance to an invitation to join the online collaborative community or a request to join the online collaborative community.

6. The method of claim 1, wherein the allowing the at least one other user to access the online collaborative community and collaborate on the I3 information comprising allowing the at least one other user to view the I3 information and provide input through the online collaborative community.

7. The method of claim 1, wherein the one of the at least one other user is a business user.

8. The method of claim 1, wherein the user and a business user have access to an online marketplace and the method further comprising:
effectuating another agreement between the user and the business user, the another agreement grants an assignment or a license of at least a portion of an intellectual property right associated with the ownership of the I3 information.

9. The method of claim 1, further comprising:
receiving a request from the user; and
publishing the I3 information to a public forum where viewing of the I3 information is not restricted by any user having access to the public forum.

10. A non-transitory computer readable medium having stored therein computer executable instructions for:
receiving, from a user, I3 information;
receiving, from the user, a request to create an online collaborative community;
associating the I3 information with the online collaborative community, wherein the I3 information can be accessed through the online collaborative community;
determining that an allowance is received from the user, the allowance indicates that at least one other user is allowed to join the online collaborative community;
determining that affirmation to join the online collaborative community is received from each of the at least one other user;
determining that each of the at least one other user provides an acceptance to an agreement, the agreement gives the user control of the online collaborative community and ownership of the I3 information, and the agreement grants the at least one other user access to the online collaborative community and the I3 information; and
allowing the at least one other user to access the online collaborative community and collaborate on the I3 information.

11. The non-transitory computer readable medium of claim 10, wherein the allowance comprises an invitation to join the online collaborative community or an acceptance to a request to join the online collaborative community.

12. The non-transitory computer readable medium of claim 10, wherein the at least one other user is allowed to join the online collaborative community based at least on a capital rating associated with one of the at least one other user.

13. The non-transitory computer readable medium of claim 10, wherein the at least one other user is allowed to join the online collaborative community based at least on a compatibility rating associated with one of the at least one other user, the compatibility rating indicates a compatibility degree between the one of the at least one other user with users in the online collaborative community, which includes the user.

14. The non-transitory computer readable medium of claim 10, wherein the determining that affirmation to join the online collaborative community comprises an acceptance to an invitation to join the online collaborative community or a request to join the online collaborative community.

15. At least one computing device comprising storage and a processor configured to perform:
receiving, from a user, I3 information;
receiving, from the user, a request to create an online collaborative community;
associating the I3 information with the online collaborative community, wherein the I3 information can be accessed through the online collaborative community;
determining that an allowance is received from the user, the allowance indicates that at least one other user is allowed to join the online collaborative community;
determining that affirmation to join the online collaborative community is received from each of the at least one other user;
determining that each of the at least one other user provides an acceptance to an agreement, the agreement gives the user control of the online collaborative community and ownership of the I3 information, and the agreement grants the at least one other user access to the online collaborative community and the I3 information; and
allowing the at least one other user to access the online collaborative community and collaborate on the I3 information.

16. The at least one computing device of claim 15, wherein the allowance comprises an invitation to join the online collaborative community or an acceptance to a request to join the online collaborative community.

17. The at least one computing device of claim 15, wherein the at least one other user is allowed to join the online collaborative community based at least on a capital rating associated with one of the at least one other user.

18. The at least one computing device of claim 15, wherein the at least one other user is allowed to join the online collaborative community based at least on a compatibility rating associated with one of the at least one other user, the compatibility rating indicates a compatibility degree between the one of the at least one other user with users in the online collaborative community, which includes the user.

19. The at least one computing device of claim 15, wherein the determining that affirmation to join the online collaborative community comprises an acceptance to an invitation to join the online collaborative community or a request to join the online collaborative community.

20. The at least one computing device of claim 15, wherein the allowing the at least one other user to access the online collaborative community and collaborate on the I3 information comprising allowing the at least one other user to view the I3 information and provide input through the online collaborative community.
